(19) United States
(12) Patent Application Publication
(10) Pub. No.: US 2025/0287928 A1
(43) Pub. Date: Sep. 18, 2025

(54) BIRD FEEDER DEVICE WITH SCREEN INSERT AND TAIL BRACE WALL

(71) Applicant: John DeBias, Jr., Annadale, NJ (US)

(72) Inventor: John DeBias, Jr., Annadale, NJ (US)

(21) Appl. No.: 18/655,819

(22) Filed: May 6, 2024

Related U.S. Application Data
(60) Provisional application No. 63/564,516, filed on Mar. 13, 2024.

(51) Int. Cl. A01K 39/012; A01K 39/01

(52) U.S. Cl. CPC A01K 39/012; A01K 39/0113

(57) ABSTRACT

A bird feeder device is provided. The device is comprised of a housing with generally parallel side walls, a rear wall, a top wall, and a bottom wall, with at least one tail brace wall on the bottom wall allowing birds to brace their tail while feeding. The housing has a front opening for bird access to food placed inside, safeguarded by a removable screen insert that can be introduced through an opening in the top wall, covering the front opening to regulate access based on food type. Additionally, the housing incorporates at least one fastener for suspending the device at an angle conducive to gravity-fed food movement towards the front opening, with design considerations such as a top wall overhang and the suspended angle of the device that aim to deter larger birds from feeding and support smaller birds.

### CROSS-REFERENCE TO RELATED APPLICATION

The present application claims priority to, and the benefit of, U.S. Provisional Application No. 63/564, 516, which was filed on Mar. 13, 2024, and is incorporated herein by reference in its entirety.

### FIELD OF THE INVENTION

The present invention relates generally to the field of bird feeders. More specifically, the present invention relates to a bird feeder device designed to only allow access to and is designed to support smaller bird species. Accordingly, the present disclosure makes specific reference thereto. Nonetheless, it is to be appreciated that aspects of the present invention are also equally applicable to other like applications, devices, and methods of manufacture.

### BACKGROUND

Existing bird feeder designs often overlook the unique needs and physical characteristics of smaller bird species, leading to significant accessibility issues for said birds. Typically constructed with the dimensions and feeding habits of average-sized birds in mind, existing feeders can pose a challenge for smaller species that not only struggle to reach the food due to their size but also face difficulties navigating the structure of the feeders. Moreover, smaller birds frequently rely on their tail feathers for balance while feeding, a critical behavior that many feeder designs fail to accommodate. This oversight can result in an uncomfortable and potentially perilous feeding experience for smaller birds, as they attempt to maintain stability and feed simultaneously.

Therefore, there exists a long-felt need in the art for an improved bird feeder. There also exists a long-felt need in the art for a bird feeder device. More specifically, there exists a long-felt need in the art for a bird feeder device that is designed to accommodate smaller bird species. Further, there exists a long-felt need in the art for a long-felt need in the art for a bird feeder device that provides an area for smaller birds to stabilize their tail while feeding from the device.

The subject matter disclosed and claimed herein, in one embodiment thereof, comprises a bird feeder device. The device is comprised of a housing with generally parallel side walls, a rear wall, a top wall, and a bottom wall, with at least one tail brace wall on the bottom wall allowing birds to brace their tail while feeding. The housing has a front opening for bird access to food placed inside, safeguarded by a removable screen insert that can be introduced through an opening in the top wall, covering the front opening to regulate access based on food type. Additionally, the housing incorporates at least one fastener for suspending the device at an angle conducive to gravity-fed food movement towards the front opening, with design considerations such as a top wall overhang and the suspended angle of the device that aim to deter larger birds from feeding and support smaller birds.

In this manner, the bird feeder device of the present invention accomplishes all the foregoing objectives and provides an improved bird feeder designed to accommodate smaller bird species. Further, the device provides an area for smaller birds to stabilize their tail while feeding from the device.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a bird feeder device comprised of a housing that is preferably rectangular or square with a pair of generally parallel side walls, a rear wall, a top wall, and a bottom wall. The bottom wall is comprised of at least one tail brace wall that is preferably perpendicular (but may be any angle between 1 and 179 degrees) relative to a horizontal axis of the bottom wall such that a bird can brace their tail against the wall when perched on the wall(s) while feeding from the device.

More specifically, the housing is comprised of at least one front opening that allows a bird to feed from a food material placed inside the interior space of the housing. The feed is protected behind at least one removable screen insert that can be placed into the interior space via at least one opening in the top wall.

The housing is also comprised of at least one fastener, such as, but not limited to, an cyclet, that allows a user to suspend the device from a structure, tree, etc., via a hook or other similar fastener. The fastener is preferably positioned on the housing such that when hung from a hook or other similar fastener the housing forms an angle between 0 and 89 degrees relative to a vertical axis of the fastener. Due to the angle of the housing when suspended, food inside the housing is moved towards the opening in a gravity-fed manner.

The present invention is also comprised of a method of using the device. First, a device is provided comprised of a housing comprised of a top wall that overhangs a front opening, a bottom wall, a tail brace wall, and a screen insert. Then, a food source can be placed into an interior space of the housing. Next, the screen insert can be placed into an interior space of the housing via an opening of the top wall such that the screen insert covers the front opening and secures the food source within the interior space. Next, the housing can be hung from a fastener at an angle between 1 and 179 degrees by attaching the fastener to a surface and then attaching the fastener to a fastener of the housing.

Accordingly, the bird feeder device of the present invention is particularly advantageous as it provides an improved bird feeder designed to accommodate smaller bird species. Further, the device provides an area for smaller birds to stabilize their tail while feeding from the device. In this manner, the bird feeder device overcomes the limitations of existing bird feeders known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a bird feeder device of the present invention while hanging in accordance with the disclosed architecture;

FIG. 2 illustrates a front view of one potential embodiment of a bird feeder device of the present invention while hanging in accordance with the disclosed architecture;

FIG. 3 illustrates a perspective view of one potential embodiment of a bird feeder device of the present invention while being used by a bird in accordance with the disclosed architecture; and

FIG. 4 illustrates a flowchart of a method of using one potential embodiment of a bird feeder device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved bird feeder. There also exists a long-felt need in the art for a bird feeder device. More specifically, there exists a long-felt need in the art for a bird feeder device that is designed to accommodate smaller bird species. Further, there exists a long-felt need in the art for a long-felt need in the art for a bird feeder device that provides an area for smaller birds to stabilize their tail while feeding from the device.

The present invention, in one exemplary embodiment, is comprised of a bird feeder device. The device is comprised of a housing that is preferably rectangular or square with a pair of generally parallel side walls, a rear wall, a top wall, and a bottom wall. The bottom wall is comprised of at least one tail brace wall. This wall is preferably perpendicular (but may be any angle between 1 and 179 degrees) relative to a horizontal axis of the bottom wall such that a bird can brace their tail against the wall when perched on the wall(s) while feeding from the device.

More specifically, the housing is comprised of at least one front opening. The opening allows a bird to feed from a food material placed inside the interior space of the housing. The feed is protected behind at least one removable screen insert that can be placed into the interior space via at least one opening in the top wall.

The housing is also comprised of at least one fastener, such as, but not limited to, an eyelet, that allows a user to suspend the device from a structure, tree, etc., via a hook or other similar fastener. The fastener is preferably positioned on the housing such that when hung from a hook or other similar fastener the housing forms an angle between 0 and 179 degrees relative to a vertical axis of the fastener. Due to the angle of the housing when suspended, food inside the housing is moved towards the opening in a gravity-fed manner.

The present invention is also comprised of a method of using the device. First, a device is provided comprised of a housing comprised of a top wall that overhangs two side walls and a bottom wall, a tail brace wall, a front opening, and a screen insert. Then, a food source can be placed into an interior space of the housing. Next, the screen insert can be placed into an interior space of the housing via an opening of the top wall such that the screen insert covers the front opening and secures the food source within the interior space. Next, the housing can be hung from a fastener at an angle between 1 and 179 degrees by attaching the fastener to a surface and then attaching the fastener to a fastener of the housing.

Accordingly, the bird feeder device of the present invention is particularly advantageous as it provides an improved bird feeder designed to accommodate smaller bird species. Further, the device provides an area for smaller birds to stabilize their tail while feeding from the device. In this manner, the bird feeder device overcomes the limitations of existing bird feeders known in the art.

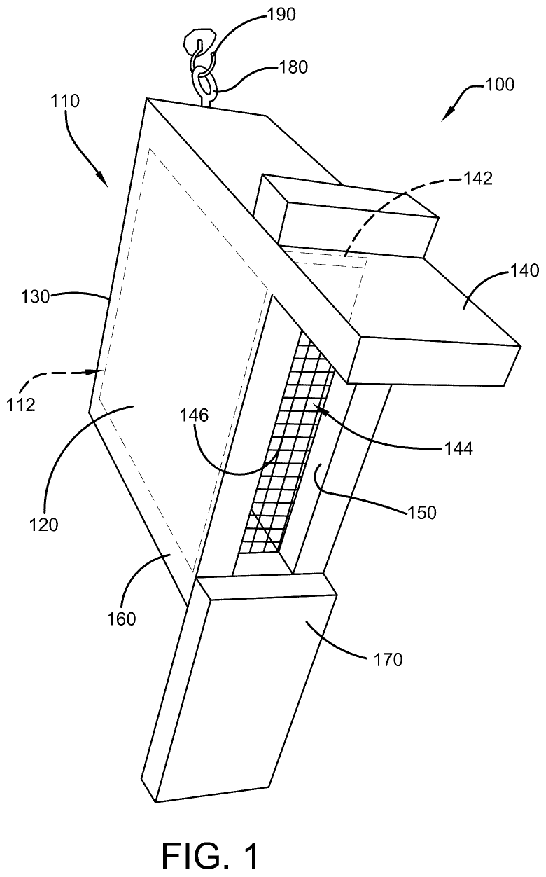

Referring initially to the drawings, FIG. 1 illustrates a perspective view of one potential embodiment of a bird feeder device 100 of the present invention while hanging in accordance with the disclosed architecture. The device 100 is comprised of a housing 110 that is preferably rectangular or square, but may be any shape in different embodiments. More specifically, the housing 110 is comprised of a pair of generally parallel side walls 120, a rear wall 130, a top wall 140, and a bottom wall 160. The housing 110 may be made from any material and may be painted or have any similar protective coating.

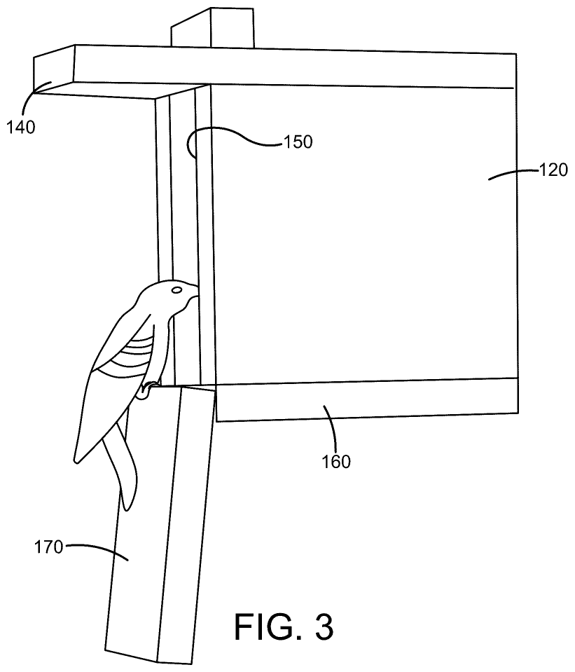

The bottom wall 160 is comprised of at least one tail brace wall 170 that is preferably perpendicular (but may be any angle between 1 and 179 degrees) relative to a horizontal axis of the bottom wall 160. As a result, a bird can brace their tail against the wall 170 when perched on the wall(s) 160, 170 while feeding from the device 100, as seen in FIG. 3.

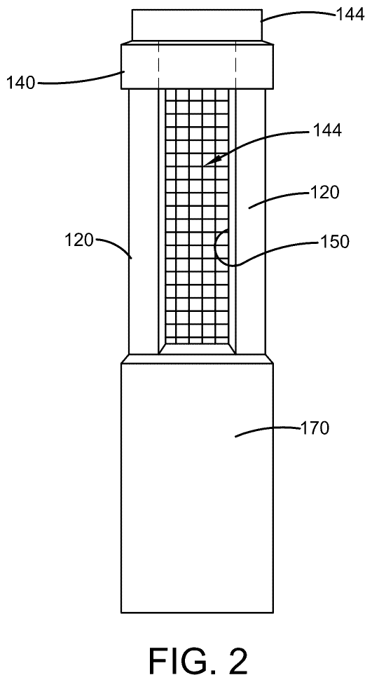

More specifically, the housing 110 is comprised of at least one front opening 150. The opening 150 allows a bird to feed from a food material placed inside the interior space 112 of the housing 110. The feed is protected behind at least one removable screen insert 144 that can be placed into the interior space 112 via at least one opening 142 in the top wall 140, wherein the insert 144 covers the opening 150, as seen in FIG. 2. The screen insert 144 may be any type of screen material with an opening 146 of any size. The opening 146 may differ in size depending upon the type of food used with the device 100 such as, but not limited to, suet, seed, dried mealworms, etc.

The housing 110 is also comprised of at least one fastener 180, such as, but not limited to, an eyelet. The fastener 180 allows a user to suspend the device 100 from a structure, tree, etc., via a hook or other similar fastener 190. The fastener 180 is preferably positioned on the housing 110 such that when hung from a hook or other similar fastener the housing 110 forms an angle between 1 and 179 degrees relative to a vertical axis of the fastener 190. Due to the angle of the housing 110 when suspended, food inside the housing 110 is moved towards the opening 150 in a gravity-fed manner.

It should be noted that the top wall 140 preferably overhangs the opening 150. This, combined with the angle the housing 110 is hung at, prevents larger birds from feeding the device.

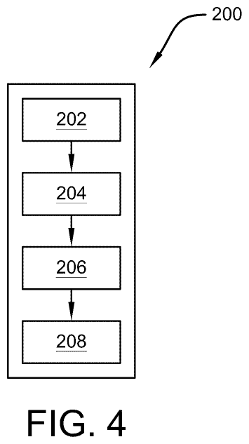

The present invention is also comprised of a method of using 200 the device 100, as seen in FIG. 4. First, a device 100 is provided comprised of a housing 110 comprised of a top wall 140 that overhangs a front opening 150, a tail brace wall 170, and a screen insert 144 [Step 202]. Then, a food source can be placed into an interior space 112 of the housing 110 [Step 204]. Next, the screen insert 144 can be placed into an interior space 112 of the housing 110 via an opening 142 of the top wall 140 such that the screen insert 144 covers the front opening 150 and secures the food source within the interior space 112 [Step 206]. Next, the housing 110 can be hung from a fastener 190 at an angle between 1 and 89 degrees by attaching the fastener 190 to a surface and then attaching the fastener 190 to a fastener 180 of the housing 110 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “bird feeder device” and “device” are interchangeable and refer to the bird feeder device 100 of the present invention.

Notwithstanding the foregoing, the bird feeder device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the bird feeder device 100 as shown in the FIGS. are for illustrative purposes only, and that many other sizes and shapes of the bird feeder device 100 are well within the scope of the present disclosure. Although the dimensions of the bird feeder device 100 are important design parameters for user convenience, the bird feeder device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A bird feeder device comprising:
a screen insert; and
a housing comprised of:
an interior space;
a bottom wall;
a front opening;
a tail brace wall extending downward from and perpendicular to a horizontal axis of the bottom wall; and
a fastener; and
wherein the screen insert is removably positional within the interior space via an opening in the top wall and is configured to cover the front opening in the housing.

2. The bird feeder device of claim 1, wherein the top wall overhangs the front opening.

3. (canceled)

4. The bird feeder device of claim 1, wherein the screen insert is comprised of an opening.

5. The bird feeder device of claim 1, wherein the housing is comprised of a square shape or a rectangular shape.

6. The bird feeder device of claim 1, wherein the fastener is comprised of an eyelet.

7. (canceled)

8. A bird feeder device comprising:
a first fastener;
a screen insert; and
a housing comprised of:
a top wall;
an interior space;
a bottom wall;
a front opening;
a tail brace wall extending downward from and perpendicular to a horizontal axis of the bottom wall; and
a second fastener; and
wherein the screen insert is removably positional within the interior space via an opening in the top wall and is configured to cover the front opening in the housing.

9. The bird feeder device of claim 8, wherein the first fastener is comprised of a hook.

10. The bird feeder device of claim 8, wherein the second fastener is comprised of an eyelet.

11. The bird feeder device of claim 8, wherein the top wall overhangs the front opening.

12. (canceled)

13. The bird feeder device of claim 8, wherein the screen insert is comprised of an opening.

14. The bird feeder device of claim 8, wherein the housing is comprised of a square shape or a rectangular shape.

15. (canceled)

16. A method of using a bird feeder device, the method comprising the following steps:
providing a bird feeder device;
placing a food source in an interior space of a the housing of the bird feeder device;
placing a removable screen insert into the interior space via an opening in a top wall of the housing; and
hanging the housing from a first fastener via a second fastener at an angle between 1 and 179 degrees.

17. The method of using a bird feeder device of claim 16, wherein the first fastener is comprised of a hook.

18. The method of using a bird feeder device of claim 16, wherein the second fastener is comprised of an eyelet.

19. The method of using a bird feeder device of claim 16, wherein the second fastener is attached to the housing.

20. The method of using a bird feeder device of claim 16, wherein the housing is comprised of a rectangular shape or a square shape.
